(19) United States
(12) Patent Application Publication
(10) Pub. No.: US 2026/0367603 A1
(43) Pub. Date: Nov. 19, 2026

(54) DISPLAY DEVICE AND CONTROL SYSTEM FOR MACHINE TOOL

(71) Applicant: FANUC CORPORPORATION, Yamanashi (JP)

(72) Inventor: Masashi YASUDA, Yamanashi (JP)

(73) Assignee: FANUC CORPORPORATION, Yamanashi (JP)

(21) Appl. No.: 19/480,779

(22) PCT Filed: May 11, 2023
(86) PCT No.: PCT/JP2023/017815

§ 371 Date: Oct. 31, 2025

(51) Int. Cl. G05B 19/406

(52) U.S. Cl. CPC G05B 19/406; G05B 2219/37084; G05B 2219/37091; G05B 2219/37352; G05B 2219/37353; G05B 2219/37357; G05B 2219/37388; G05B 2219/45044

(57) ABSTRACT

The present invention provides a technology capable of easily grasping acceleration or jerking of a machine tool in oscillating machining. A display device 1 of a machine tool includes: a machining condition acquisition unit 11 that acquires at least a frequency parameter and an amplitude parameter as machining conditions for performing oscillating machining; a calculation unit 12 that calculates acceleration information including acceleration and/or jerking of an oscillating operation on the basis of at least the frequency parameter and the amplitude parameter; and a display control unit 15 that displays an image based on the acceleration information on a display unit 20.

### TECHNICAL FIELD

The present disclosure relates to a display device and a control system for a machine tool.

### BACKGROUND ART

Conventionally, in a machine tool that executes oscillation machining, a technique of displaying various parameters such as a feed speed to set a machining condition has been known (for example, Patent Document 1).

### CITATION LIST

### Patent Document

Patent Document 1: Japanese Unexamined Patent Application, Publication No. 2023-000009

### DISCLOSURE OF THE INVENTION

### Problems to be Solved by the Invention

The machining condition needs to be set before operation of the machine tool, and in this stage of setting the machining condition, a force acting on the machine tool needs to be grasped in some cases. However, in cutting machining in which oscillation is performed, the force acting on the machine tool cannot be grasped unless the machine tool actually executes the oscillation.

In the operation of the machine tool, as an acceleration or a jerk increases, a burden on the machine tool increases, which may lead to a defect. For this reason, the acceleration or the jerk may be used as an index indicating the force acting on the machine tool. However, in the oscillation machining, the availability of air cut mutually relates to a frequency parameter and an amplitude parameter, and for this reason, it is complicated that the acceleration or the jerk is calculated and checked in a stage of setting the machining condition by an operator.

The present disclosure has been made in view of the above-described problem, and is intended to provide a technique capable of easily grasping the acceleration or jerk of a machine tool in oscillation machining.

### Means for Solving the Problems

The present disclosure is a display device for a machine tool that performs oscillation machining while finely cutting a chip by oscillating a cutting tool and a workpiece relative to each other, which includes a machining condition acquisition unit that acquires at least a frequency parameter and an amplitude parameter as machining conditions for performing the oscillation machining, a calculation unit that calculates acceleration information including an acceleration, a jerk, or both in oscillation at least based on the frequency parameter and the amplitude parameter, and a display control unit that displays, on a display unit, an image based on the acceleration information.

Moreover, the present disclosure is a control system including a control device and a display device for a machine tool that performs oscillation machining while finely cutting a chip by oscillating a cutting tool and a workpiece relative to each other, which includes a machining condition acquisition unit located in the control device to acquire at least a frequency parameter and an amplitude parameter as machining conditions for performing the oscillation machining, an oscillation generation unit located in the control device to generate oscillation based on the machining conditions, a drive control unit located in the control device to control an operation axis based on the oscillation generated by the oscillation generation unit, a calculation unit located in the display device or the control device to calculate acceleration information including an acceleration, a jerk, or both in the oscillation at least based on the frequency parameter and the amplitude parameter, and a display control unit located in the display device to display, on a display unit, an image based on the acceleration information during the oscillation by the drive control unit.

### BRIEF DESCRIPTION OF THE DRAWINGS

FIG. 1 is a functional block diagram of a display device for a machine tool according to a first embodiment;

FIG. 2 is a flowchart showing one example of the flow of display control processing by the display device;

FIG. 3 is a view showing an image example displayed on a display unit by the display device;

FIG. 4 is a functional block diagram of a display device for a machine tool according to a second embodiment; and

FIG. 5 is a functional block diagram of a control system according to a third embodiment.

### PREFERRED MODE FOR CARRYING OUT THE INVENTION

Hereinafter, embodiments of the present disclosure will be described in detail with reference to the drawings. Note that in the description of a second embodiment and embodiments subsequent thereto, components common to those of a first embodiment are denoted by the same reference numerals and the description thereof will be omitted as necessary.

### First Embodiment

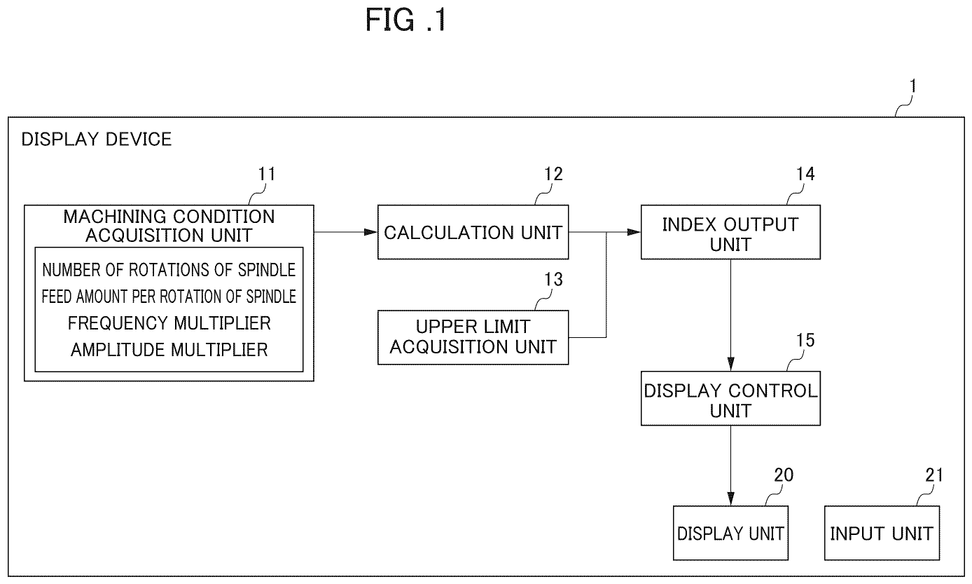

FIG. 1 is a functional block diagram of a display device 1 for a machine tool according to the first embodiment. The display device 1 according to the first embodiment is a computer that displays, on a display unit 20, various types of information on the machine tool that performs oscillation machining while oscillating a cutting tool and a workpiece relative to each other. The display device 1 is used by being connected to a control device (not shown) which is a computer that controls the machine tool, for example.

The machine tool machines the workpiece with the cutting tool by operating at least one spindle for rotating the cutting tool and the workpiece relative to each other and at least one feed shaft for moving the cutting tool relative to the workpiece. The machine tool executes various types of machining based on a machining program.

Note that in the machining by the machine tool according to the present embodiment, the shape of the workpiece is not limited. That is, even in a case where a plurality of feed shafts (Z-axis and X-axis) is necessary because the workpiece has a tapered portion or an arc-shaped portion in a machining surface, or even in a case where the workpiece is in a circular columnar shape or a cylindrical shape and one specific feed shaft (Z-axis) is enough, the machine tool is applicable.

A hardware configuration of the display device 1 for the machine tool will be described. The display device 1 is configured using, for example, a computer including a memory such as a read only memory (ROM) or a random access memory (RAM), a control processing unit (CPU), and a communication control unit, which are connected to each other via a bus.

Further, the display device 1 includes the display unit 20 that displays various types of information and an input unit 21 that receives various types of information input by an operator. The display unit 20 includes, for example, a display that displays various types of information. The input unit 21 is, for example, operation means such as a touch panel, a keyboard, or a button.

The display device 1 for the machine tool may be configured as a computer numerical controller (CNC), or may be connected to a higher-level computer (not shown) such as a CNC or a programmable logic controller (PLC). From the higher-level computer, not only the machining program but also a machining condition such as a rotation speed or the like may be input to the display device 1 for the machine tool.

Next, functional units implemented in the display device 1 will be described. The display device 1 includes, as the functional units, a machining condition acquisition unit 11, a calculation unit 12, an upper limit acquisition unit 13, an index output unit 14, and a display control unit 15. These functional units of the display device 1 are implemented by cooperation of the above-described CPU and memory and a control program stored in the memory.

The machining condition acquisition unit 11 is a machining condition acquisition function of acquiring machining conditions for performing the oscillation machining. The machining conditions may be input to the display device 1 by the operator via the input unit 21, an external computer, or the like according to an item displayed on the display unit 20 of the display device 1, or may be automatically acquired from the machining program, a set parameter for the machine tool, or the like.

The machining conditions include information necessary for the machining, such as the number of rotations (1/min) of the spindle, a feed amount (mm/rev) per rotation of the spindle, a command location of the feed shaft, an oscillation condition, and the like. Note that the feed amount (mm/rev) per rotation of the spindle may be calculated from a combination of the number of rotations (1/min) of the spindle and the feed speed (mm/min) of the cutting tool.

The oscillation condition in the machining conditions will be described. The oscillation condition includes, as information for uniquely identifying an oscillatory waveform, at least a frequency parameter which is information regarding the oscillation frequency of the cutting tool or the workpiece and an amplitude parameter which is information regarding the oscillation amplitude of the cutting tool or the workpiece. The frequency parameter may be the number of oscillations per relative rotation of the cutting tool and the workpiece, or may be the number of oscillations per unit time. Alternatively, the frequency parameter may be a forward/backward operation period parameter. The amplitude parameter may be information regarding an oscillation amplitude with respect to a feed amount per relative rotation of the cutting tool and the workpiece, or may be a forward/backward operation distance parameter. These forward/backward operation period parameter and forward/backward operation distance parameter may be determined from a forward movement speed, a backward movement speed, a forward movement distance, a backward movement distance, the number of rotations of the spindle, a control period, or the like. The frequency parameter and the amplitude parameter may be determined from the number of rotations of the spindle, a feed speed per rotation, a feed speed per minute, a frequency multiplier which is the number of oscillations per relative rotation of the cutting tool and the workpiece, an amplitude multiplier which is an oscillation amplitude with respect to a feed amount per relative rotation of the cutting tool and the workpiece, or the like. The frequency multiplier and the amplitude multiplier may be calculated based on the above-described plurality of conditions.

In the present embodiment, as the frequency parameter, an oscillation frequency multiplier I (times) indicating an oscillation frequency per rotation of the spindle is used. The oscillation frequency multiplier I (times) is directly specified by the operator via the input unit 21.

As the amplitude parameter, an oscillation amplitude multiplier K (times) indicating the magnitude of an oscillation amplitude with respect to the magnitude of a feed amount per rotation of the spindle is used. Similarly, the oscillation amplitude multiplier K (times) is also directly specified by the operator via the input unit 21.

Alternatively, a method of acquiring the values of the frequency multiplier and the amplitude multiplier themselves from input from the external computer, the machining program, or the set parameter may be employed. The availability of air cut is determined only from two parameters which are the frequency multiplier and the amplitude multiplier, and therefore, by directly setting two conditions for the frequency multiplier and the amplitude multiplier as a condition for oscillation cutting, a condition for the air cut is easily set. Thus, this setting method is a common method.

The calculation unit 12 is a calculation function of calculating acceleration information including at least one of the acceleration or jerk of the feed shaft in the oscillation based on the machining conditions. In the present embodiment, the calculation unit 12 calculates both the acceleration and the jerk using at least the frequency parameter and the amplitude parameter in the machining conditions.

The upper limit acquisition unit 13 acquires the upper limit of at least one of the acceleration or the jerk. The upper limit may be stored in advance in the display device 1 as a parameter for the machine tool, or may be input by the operator via the input unit 21.

The index output unit 14 outputs the indices of the acceleration and the jerk based on the acceleration information calculated by the calculation unit 12 and the upper limit of the acceleration and the upper limit of the jerk acquired by the upper limit acquisition unit 13. In the present embodiment, the index output unit 14 calculates the indices as the ratios of the acceleration and the jerk to their respective upper limits calculated by the calculation unit 12. Moreover, the index output unit 14 outputs the indices of the acceleration and the jerk based on the acceleration and the jerk calculated by the calculation unit 12 and the upper limits of the acceleration and the jerk acquired by the upper limit acquisition unit 13. The index output unit 14 calculates the indices as the ratios of the acceleration and the jerk to their respective upper limits calculated by the calculation unit 12. The ratio may be a percentage or a ratio.

Note that the index output unit 14 is not limited to a configuration of outputting the index in the form of a numerical value such as a ratio. For example, the index output unit 14 may output the index at a plurality of levels determined in advance, or may express the index such that the degree of change is distinguishable by a text or a sign.

The display control unit 15 is a display control function of displaying, on the display unit 20, various types of information on the display device 1 and information on an operator's input result. Moreover, the display control unit 15 executes display control of displaying, on the display unit 20, an image based on the acceleration information. In the display control, the ratios of the acceleration and the jerk to their respective upper limits are displayed, on the display unit 20, as the image based on the acceleration information.

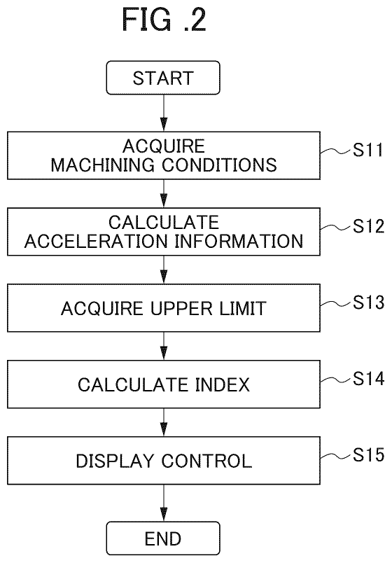

Next, the flow of the display control processing will be described with reference to FIG. 2. FIG. 2 is a flowchart showing one example of the flow of the display control processing by the display device. Note that the order and contents of the processing shown in the flowchart are merely an example and can be changed as necessary.

First, the machining condition acquisition unit 11 acquires the machining conditions from the operator's input, the machining program, or the machine tool parameter (Step S11). The machining conditions acquired by the machining condition acquisition unit 11 are, for example, the number of rotations S (rev/min) of the spindle, a feed amount F (mm/rev), the oscillation frequency multiplier I (times), the oscillation amplitude multiplier K (times), and the like.

Next, the calculation unit 12 calculates the acceleration and the jerk as the acceleration information based on the machining conditions acquired by the machining condition acquisition unit 11. In this example, the machining condition acquisition unit 11 calculates the maximum acceleration and the maximum jerk. Note that the acceleration and the jerk calculated by the machining condition acquisition unit 11 are not limited to the maximum values.

One example of a calculation method will be described. The calculation unit 12 calculates the maximum acceleration based on Mathematical Expression (1). Moreover, the calculation unit 12 calculates the maximum jerk based on Mathematical Expression (2). In each mathematical expression, Amax represents the maximum acceleration, Jₘₐₓ represents the maximum jerk, K represents the oscillation amplitude multiplier, f represents the feed amount, S represents the number of rotations of the spindle, and I represents the oscillation frequency multiplier.

[Mathematical Expression 1]

Aₘₐₓ=(K×f)×(2π×S'I)²/2 Mathematical Expression (1)

[Mathematical Expression 2]

Jₘₐₓ=(K×f)×(2π×S×I)³/2 Mathematical Expression (2)

Next, the upper limit acquisition unit 13 acquires the acceleration upper limit Aᵤₚ and the jerk upper limit Jᵤₚ set in advance from the parameter for the machine tool from the storage unit of the display device 1 or the control device, or the like (Step S13).

Next, the index output unit 14 outputs an acceleration index indicating the degree of the maximum acceleration Amax with respect to the acceleration upper limit Aᵤₚ and a jerk index indicating the degree of the maximum jerk Jₘₐₓ with respect to the jerk upper limit Jᵤₚ (Step S14).

In this example, the index output unit 14 outputs, as the acceleration index, YA which is the ratio (ratio) of the maximum acceleration Aₘₐₓ to the acceleration upper limit Aᵤₚ based on Mathematical Expression (3). Moreover, the index output unit 14 outputs, as the jerk index, YJ which is the ratio (ratio) of the maximum jerk Jmax to the jerk upper limit Jᵤₚ based on Mathematical Expression (4).

[Mathematical Expression 3]

YA=Aₘₐₓ/Aᵤₚ Mathematical Expression (3)

[Mathematical Expression 4]

YJ=Jₘₐₓ/Jᵤₚ Mathematical Expression (4)

Next, the display control unit 15 executes display control of displaying, on the display unit 20, the acceleration information including the maximum acceleration Aₘₐₓ and the maximum jerk Jₘₐₓ as an image based on the acceleration information.

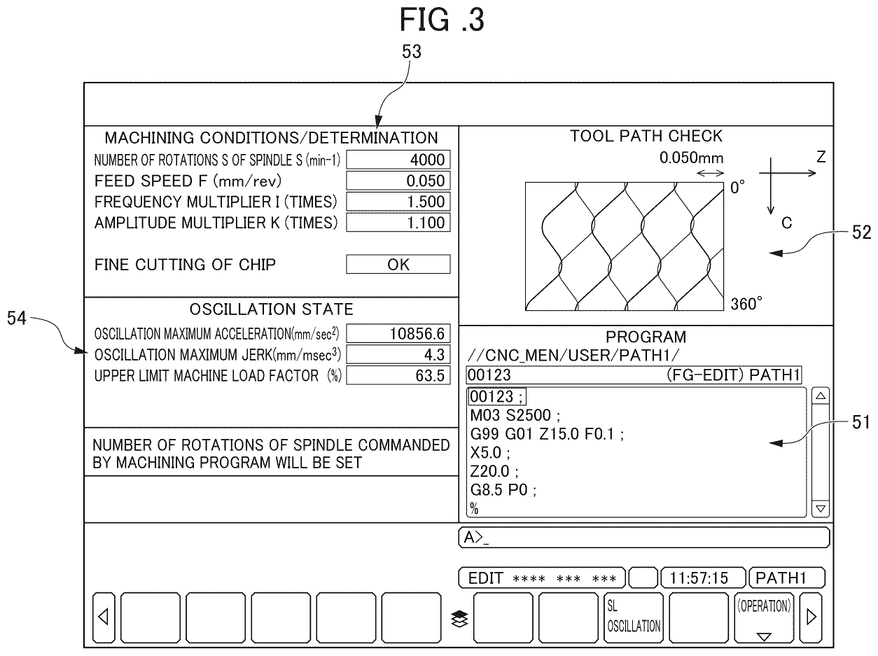

The image displayed on the display unit 20 by the display control unit 15 will be described with reference to FIG. 3.

FIG. 3 is a view showing an image example displayed on the display unit 20 by the display device 1.

The image shown in FIG. 3 includes a program item 51 indicating the contents of the machining program, a tool path checking item 52 indicating a cutting tool machining path, a condition item 53 indicating the machining conditions and a determination result, and an acceleration information item 54 indicating the information regarding the acceleration.

In this example, the condition item 53 include information indicating the number of rotations S (rev/min) of the spindle, the feed amount F (mm/rev), the oscillation frequency multiplier I (times), the oscillation amplitude multiplier K (times), and the availability of the air cut.

The acceleration information item 54 indicate the maximum acceleration Aₘₐₓ and the maximum jerk Jₘₐₓ, and also indicates an upper limit machine load factor (%). The upper limit machine load factor (%) is the ratio (ratio) of the maximum acceleration Aₘₐₓ to the acceleration upper limit Aᵤₚ, the ratio (ratio) of the maximum jerk Jₘₐₓ to the jerk upper limit Jᵤₚ, or information calculated based on their ratios.

The following effects are obtained according to the display device 1 of the first embodiment for the machine tool that performs the oscillation machining while oscillating the cutting tool and the workpiece relative to each other.

The display device 1 for the machine tool according to the present embodiment includes the machining condition acquisition unit 11 that acquires at least the frequency parameter and the amplitude parameter as the machining conditions for performing the oscillation machining, the calculation unit 12 that calculates the acceleration information including the acceleration, the jerk, or both in the oscillation at least based on the frequency parameter and the amplitude parameter, and the display control unit 15 that displays, on the display unit 20, the image based on the acceleration information.

With this configuration, even in a stage of setting the machining conditions before actual operation of the machine tool, information indicating a force acting on the machine tool, such as the acceleration and the jerk, can be grasped. Although there is, other than the case of the oscillation cutting, a case where the oscillation is intentionally controlled, the availability of the air cut mutually relates to the frequency parameter and the amplitude parameter particularly in the oscillation cutting, and therefore, these two parameters which are the frequency parameter and the amplitude parameter need to be adjusted simultaneously. It is complicated that the acceleration and the jerk are simultaneously calculated and checked while a combination of the frequency parameter and the amplitude parameter, which allows the air cut, is taken into consideration. On this point, according to the configuration of the present embodiment, since the acceleration information including the automatically calculated acceleration and jerk is displayed on the display unit 20, the operator can easily grasp the force acting on the machine tool from the acceleration and the jerk.

In the present embodiment, the machining condition acquisition unit 11 acquires, as the machining conditions, the number of rotations of the spindle, the feed amount per rotation of the spindle, the frequency multiplier as the frequency parameter which is the number of oscillations per rotation of the spindle, and the amplitude multiplier as the amplitude parameter which is the amplitude ratio with respect to the feed amount per rotation of the spindle, and the calculation unit 12 calculates the acceleration information on the oscillation based on the number of rotations of the spindle, the feed amount per rotation of the spindle, the frequency multiplier, and the amplitude multiplier. With this configuration, the frequency parameter can be set as the oscillation frequency multiplier and the amplitude parameter can be set as the oscillation amplitude multiplier in the oscillation machining, and therefore, the availability of the air cut is easily determined. The availability of the air cut is determined only from two parameters which are the frequency multiplier and the amplitude multiplier, and therefore, by directly setting two conditions for the frequency multiplier and the amplitude multiplier as the condition for the oscillation cutting, the condition for the air cut is easily set. Thus, this setting method is the common method. It is further complicated, on the other hand, that the acceleration and the jerk are calculated and checked from two parameters which are the frequency multiplier and the amplitude multiplier.

The display device 1 of the present embodiment includes the upper limit acquisition unit 13 that acquires the upper limits set for the acceleration and the jerk, and the index output unit 14 that outputs the index indicating the degree of the acceleration with respect to the set upper limit and the index indicating the degree of the jerk with respect to the set upper limit, and the display control unit 15 displays the indices on the display unit 20. As the acceleration, the jerk, and the force acting on the machine tool increase, the oscillation of the entire machine tool becomes greater, and for this reason, the operator cannot perform operation with security. On this point, according to the configuration of the present embodiment, the upper limit is set to avoid the oscillation of the machine tool, therefore, an index indicating a magnitude relationship between the force acting on the machine based on the machining conditions, such as the acceleration and the jerk, and the upper limit is output. The operator can intuitively grasp the degree of oscillation based on the index.

### Second Embodiment

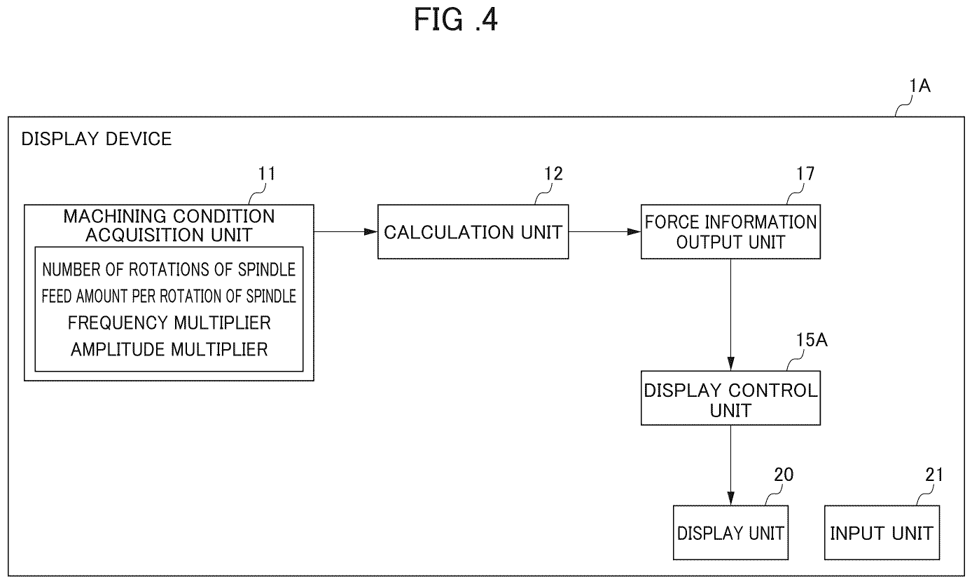

Next, a display device 1A of the second embodiment having a configuration different from that of the display device 1 of the first embodiment will be described with reference to FIG. 4. FIG. 4 is a functional block diagram of the display device 1A for the machine tool according to the second embodiment.

Note that in the description below, components similar or common to those of the above-described embodiment are denoted by the same reference numerals and the detailed description thereof may be omitted.

As shown in FIG. 4, the display device 1A of the second embodiment includes, as functional units, the machining condition acquisition unit 11, the calculation unit 12, a force information output unit 17, and a display control unit 15A. Note that the display device 1A of the second embodiment includes hardware similar to that of the display device 1 of the first embodiment.

In the second embodiment, the force information output unit 17 acquires, as a mass parameter, the weight and inertia of the cutting tool of the machine tool or the workpiece. The weight and the inertia may be stored in advance in a storage unit (not shown) of the display device 1A, or may be input by the operator according to a display screen of the display unit 20.

Then, the force information output unit 17 outputs, as force information, a force acting on the machine tool or a torque based on the acceleration information including the acceleration calculated by the calculation unit 12 and the weight or the inertia. The force acting on the machine tool can be calculated using an expression F (force)=m (mass)×a (acceleration), for example. The torque can be calculated using T (torque)=I (inertia)×a (angular acceleration), for example. Note that the methods for calculating the force and the torque are not limited thereto, and other methods can be employed.

Next, the display control unit 15A displays, on the display unit 20, an image including the force information based on the acceleration information. Note that the force information may be only the force or the torque, or may be both. The force information including the weight or the inertia may be displayed. Alternatively, the display control unit 15A may execute display control of displaying, on the display unit 20, an image including the acceleration or the jerk as calculation source data, the weight, or the inertia in addition to the force information.

As described above, the display device 1A of the second embodiment further includes the force information output unit 17 that acquires the mass parameter including the mass, the inertia, or both and outputs the force, the torque, or both in the oscillation based on the mass parameter and the acceleration information, and the display control unit 15A displays, on the display unit 20, the force, the torque, or both in the oscillation. With this configuration, the numerical value of the force or the torque generated in the oscillation can be checked, and a load on the machine tool can be directly grasped.

### Third Embodiment

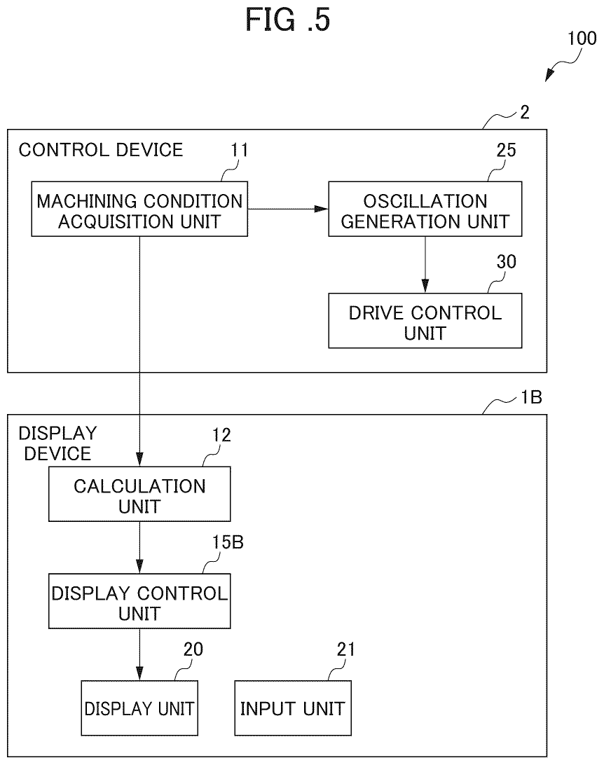

Next, a control system 100 including a control device 2 and a display device 1B for a machine tool that performs oscillation machining while oscillating a cutting tool and a workpiece relative to each other will be described with reference to FIG. 5. FIG. 5 is a functional block diagram of the control system 100 according to the third embodiment.

The control device 2 of the control system 100 is a computer that controls the machine tool that performs the machining while moving the cutting tool and the workpiece relative to each other. The configuration of the machine tool is similar to that of the first embodiment.

First, the control device 2 will be described. The control device 2 is configured using a computer including a memory such as a ROM or a RAM, a CUP, a communication control unit, and a display screen such as a display, which are connected to each other via a bus, for example. The control device 2 for the machine tool may be configured as a CNC, or may be connected to a higher-level computer (not shown) such as a CNC or a PLC. From the higher-level computer, not only a machining program but also a machining condition such as a rotation speed and the like are input to the control device 2 for the machine tool.

The control device 2 includes, as functional units, a machining condition acquisition unit 11, an oscillation generation unit 25, and a drive control unit 30. These functional units of the control device 2 are implemented by cooperation of the above-described CPU and memory and a control program stored in the memory.

Of the components of the control device 2, the machining condition acquisition unit 11 has a function similar to that of the machining condition acquisition unit 11 of the first embodiment. The oscillation generation unit 25 generates oscillation based on the machining condition acquired by the machining condition acquisition unit 11. Note that an acceleration generated by the oscillation generation unit 25 may be generated considering another element other than the machining condition.

The drive control unit 30 is an axis control function of controlling, when receiving the oscillation generated by the oscillation generation unit 25 from the oscillation generation unit 25, an operation axis based on the contents of the oscillation.

The display device 1B includes, as functional units, a calculation unit 12 and a display control unit 15B. A hardware configuration of the display device 1B is similar to that of the display device 1 of the first embodiment, and these functional units of the display device 1B are implemented by cooperation of the CPU, the memory, and the control program stored in the memory.

The calculation unit 12 has a function similar to that of the calculation unit 12 of the first embodiment. The display control unit 15B executes, during the control of the oscillation by the drive control unit 30, display control of displaying, on the display unit 20, an image including the acceleration and the jerk calculated by the calculation unit 12. The display control unit 15B may display the maximum acceleration and the maximum jerk, or may display the sequentially-changing acceleration and jerk in real time.

As described above, the control system 100 of the third embodiment includes the machining condition acquisition unit 11 located in the control device 2 to acquire at least the frequency parameter and the amplitude parameter as the machining conditions for performing the oscillation machining, the oscillation generation unit 25 located in the control device 2 to generate the oscillation based on the machining processing, the drive control unit 30 located in the control device 2 to control the operation axis based on the oscillation generated by the oscillation generation unit 25, the calculation unit 12 located in the display device 1B to calculate the acceleration information including the acceleration, the jerk, or both in the oscillation at least based on the frequency parameter and the amplitude parameter, and the display control unit 15 located in the display device 1B to display, on the display unit 20, the image based on the acceleration information during the oscillation by the drive control unit 30.

With this configuration, even while the oscillation is actually executed by the machine, the information indicating the force acting on the machine tool, such as the acceleration and the jerk, can be grasped. Since the acceleration and the jerk during the oscillation can be grasped, the upper limit of the machine load can be easily set based on the acceleration and the jerk in consideration of the oscillation state of the machine tool or the like.

In the third embodiment described above, the configuration in which the calculation unit 12 is located on the display device 1B side has been described as an example, but the location of the calculation unit 12 is not limited to the display device 1B. For example, the calculation unit 12 may be located in the control device 2.

In the above-described embodiment, the machining condition acquisition unit 11 directly acquires four parameters which are the number of rotations S (rev/min) of the spindle, the feed amount F (mm/rev), the oscillation frequency multiplier I (times), and the oscillation amplitude multiplier K (times), but the present disclosure is not limited to this configuration. For example, the machining condition acquisition unit 11 may be configured to calculate and indirectly acquire the number of rotations S (rev/min) of the spindle, the feed amount F (mm/rev), the oscillation frequency multiplier I (times), and the oscillation amplitude multiplier K (times) from another piece of information. Further, the display device and the control device may be configured as a single integrated computer.

Note that the present disclosure is not limited to the above-described embodiments and modifications and changes and modifications made within the scope in which the object of the present disclosure can be achieved are included in the present disclosure.

Regarding the above-described embodiments and modifications, the following additional remarks will be further disclosed.

### Additional Remark 1

A display device (1, 1A) for a machine tool that performs oscillation machining while finely cutting a chip by oscillating a cutting tool and a workpiece relative to each other, the display device (1, 1A) includes
a machining condition acquisition unit (11) that acquires at least a frequency parameter and an amplitude parameter as machining conditions for performing the oscillation machining,
a calculation unit (12) that calculates acceleration information including an acceleration, a jerk, or both in oscillation at least based on the frequency parameter and the amplitude parameter, and
a display control unit (15) that displays, on a display unit, an image based on the acceleration information.

### Additional Remark 2

In the above-described display device (1, 1A),
the machining condition acquisition unit (11) acquires, as the machining condition, the number of rotations of a spindle, a feed amount per rotation of the spindle, a frequency multiplier as the frequency parameter which is the number of oscillations per rotation of the spindle, and an amplitude multiplier as the amplitude parameter which is an amplitude ratio with respect to the feed amount per rotation of the spindle, and
the calculation unit (12)
calculates the acceleration information on the oscillation based on the number of rotations of the spindle, the feed amount per rotation of the spindle, the frequency multiplier, and the amplitude multiplier.

### Additional Remark 3

The above-described display device (1) further includes
an upper limit acquisition unit (13) that acquires an upper limit set for the acceleration or the jerk, and
an index output unit (14) that outputs an index indicating the degree of the acceleration with respect to the set upper limit or the degree of the jerk with respect to the set upper limit, in which the display control unit (15) displays the index on the display unit (20).

### Additional Remark 4

The above-described display device (1A) further includes
a force information output unit (17) that acquires a mass parameter including a mass, an inertia, or both and outputs a force, a torque, or both in the oscillation based on the mass parameter and the acceleration information,
in which the display control unit (15A) displays, on the display unit (20), the force, the torque, or both in the oscillation.

### Additional Remark 5

A control system (100) including a control device (2) and a display device (1B) for a machine tool that performs oscillation machining while finely cutting a chip by oscillating a cutting tool and a workpiece relative to each other, the control system (100) includes
a machining condition acquisition unit (11) located in the control device (2) to acquire at least a frequency parameter and an amplitude parameter as machining conditions for performing the oscillation machining,
an oscillation generation unit (25) located in the control device (2) to generate oscillation based on the machining conditions,
a drive control unit (30) located in the control device (2) to control an operation axis based on the oscillation generated by the oscillation generation unit (25),
a calculation unit located in the display device (1B) or the control device (2) to calculate acceleration information including an acceleration, a jerk, or both in the oscillation at least based on the frequency parameter and the amplitude parameter, and
a display control unit (15) located in the display device (1B) to display, on a display unit (20), an image based on the acceleration information during the oscillation by the drive control unit (30).

### EXPLANATION OF REFERENCE NUMERALS

1, 1A, 1B Display Device for Machine Tool
2 Control Device for Machine Tool
11 Machining Condition Acquisition Unit
12 Calculation Unit
13 Upper Limit Acquisition Unit
14 Index Output Unit
15, 15A, 15B Display Control Unit
17 Force Information Output Unit
20 Display Unit
25 Oscillation Generation Unit
30 Drive Control Unit
100 Control System

1. A display device for a machine tool that performs oscillation machining while finely cutting a chip by oscillating a cutting tool and a workpiece relative to each other, the display device comprising:
a machining condition acquisition unit that acquires at least a frequency parameter and an amplitude parameter as machining conditions for performing the oscillation machining;
a calculation unit that calculates acceleration information including an acceleration, a jerk, or both in oscillation at least based on the frequency parameter and the amplitude parameter; and
a display control unit that displays, on a display unit, an image based on the acceleration information.

2. The display device for the machine tool according to claim 1, wherein
the machining condition acquisition unit
acquires, as the machining conditions, the number of rotations of a spindle, a feed amount per rotation of the spindle, a frequency multiplier as the frequency parameter which is the number of oscillations per rotation of the spindle, and an amplitude multiplier as the amplitude parameter which is an amplitude ratio with respect to the feed amount per rotation of the spindle, and
the calculation unit
calculates the acceleration information on the oscillation based on the number of rotations of the spindle, the feed amount per rotation of the spindle, the frequency multiplier, and the amplitude multiplier.

3. The display device for the machine tool according to claim 1, further comprising:
an upper limit acquisition unit that acquires an upper limit set for the acceleration or the jerk; and
an index output unit that outputs an index indicating a degree of the acceleration with respect to the set upper limit or a degree of the jerk with respect to the set upper limit,
wherein the display control unit displays the index on the display unit.

4. The display device for the machine tool according to claim 1, further comprising:
a force information output unit that acquires a mass parameter including a mass, an inertia, or both and outputs a force, a torque, or both in the oscillation based on the mass parameter and the acceleration information,
wherein the display control unit displays, on the display unit, the force, the torque, or both in the oscillation.

5. A control system including a control device and a display device for a machine tool that performs oscillation machining while finely cutting a chip by oscillating a cutting tool and a workpiece relative to each other, the control system comprising:
a machining condition acquisition unit located in the control device to acquire at least a frequency parameter and an amplitude parameter as machining conditions for performing the oscillation machining;
an oscillation generation unit located in the control device to generate oscillation based on the machining conditions;
a drive control unit located in the control device to control an operation axis based on the oscillation generated by the oscillation generation unit;
a calculation unit located in the display device or the control device to calculate acceleration information including an acceleration, a jerk, or both in the oscillation at least based on the frequency parameter and the amplitude parameter; and
a display control unit located in the display device to display, on a display unit, an image based on the acceleration information during the oscillation by the drive control unit.
